(19) United States
(12) Patent Application Publication
(10) Pub. No.: US 2026/0046060 A1
(43) Pub. Date: Feb. 12, 2026

(54) 4X LTF SEQUENCE DESIGN FOR WIDE BANDWIDTHS IN WIRELESS COMMUNICATIONS

(71) Applicant: MEDIATEK INC., Hsinchu City (TW)

(72) Inventors: Shengquan HU, San Jose, CA (US); Jianhan LIU, San Jose, CA (US); Thomas Edward PARE, JR., San Jose, CA (US)

(21) Appl. No.: 19/104,294

(22) PCT Filed: Sep. 13, 2023
(86) PCT No.: PCT/CN2023/118532

§ 371 Date: Feb. 17, 2025

Related U.S. Application Data
(60) Provisional application No. 63/375,555, filed on Sep. 14, 2022.

(51) Int. Cl. H04L 1/00; H04W 28/02; H04W 84/12

(52) U.S. Cl. CPC H04L 1/0006; H04W 28/0231; H04W 84/12

(57) ABSTRACT

Various schemes pertaining to four times (4×) long-training field (LTF) sequence design for wide bandwidths in wireless communications are described. A processor of an apparatus generates an LTF of a physical-layer protocol data unit (PPDU) with a 78.125 kHz subcarrier spacing by using a predefined LTF base sequence. The apparatus then performs a wireless communication in a 240 MHz, 480 MHz or 640 MHz bandwidth with the PPDU.

### CROSS REFERENCE TO RELATED PATENT APPLICATION

The present disclosure is part of a non-provisional patent application claiming the priority benefit of U.S. Provisional Patent Application No. 63/375,555, filed 14 Sep. 2022, the content of which being incorporated by reference in its entirety.

### TECHNICAL FIELD

The present disclosure is generally related to wireless communications and, more particularly, to techniques pertaining to four times (4×) long-training field (LTF) sequence design for wide bandwidths in wireless communications.

### BACKGROUND

Unless otherwise indicated herein, approaches described in this section are not prior art to the claims listed below and are not admitted as prior art by inclusion in this section.

In wireless communications, such as Wi-Fi (or WiFi) and wireless local area networks (WLANs) in accordance with one or more Institute of Electrical and Electronics Engineers (IEEE) 802.11 standards, achieving high throughput is one of the key objectives for next-generation wireless connectivity. Wider bandwidths, such as 240 MHz, 480 MHz and 640 MHz, have been considered as potential candidates for next-generation WLAN. However, at present time, how to achieve high throughput in wide bandwidths, such as 240 MHz, 480 MHz and 640 MHz, remains to be defined. Therefore, there is a need for a solution of 4x LTF sequence design for wide bandwidths in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to 4×LTF sequence design for wide bandwidths in wireless communications. Under various proposed schemes described herein, a 4×LTF sequence design may be utilized for wide bandwidths such as 240 MHz, 480 MHz and 640 MHz. Moreover, several design options are proposed with peak-to-average power ratio (PAPR) performance evaluated for comparison. It is believed that implementations of the proposed schemes may address or otherwise alleviate aforementioned issues.

In one aspect, a method may involve generating an LTF of a physical-layer protocol data unit (PPDU) with a 78.125 kHz subcarrier spacing by using a predefined LTF base sequence. The method may also involve performing a wireless communication in a 240 MHz, 480 MHz or 640 MHz bandwidth with the PPDU.

In another aspect, an apparatus may include a transceiver and a processor coupled to the transceiver. The transceiver may be configured to transmit and receive wirelessly. The processor may be configured to generate an LTF of a PPDU with a 78.125 kHz subcarrier spacing by using a predefined LTF base sequence. The processor may be also configured to perform a wireless communication in a 240 MHz, 480 MHz or 640 MHz bandwidth with the PPDU.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5th Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario in accordance with an implementation of the present disclosure.

FIG. 3A and FIG. 3B each is a respective portion of an example design in accordance with an implementation of the present disclosure.

FIG. 4 is a diagram of an example design in accordance with an implementation of the present disclosure.

FIG. 5 is a diagram of an example scenario in accordance with an implementation of the present disclosure.

FIG. 6 is a diagram of an example scenario in accordance with an implementation of the present disclosure.

FIG. 7 is a diagram of an example design in accordance with an implementation of the present disclosure.

FIG. 8 is a diagram of an example scenario in accordance with an implementation of the present disclosure.

FIG. 9 is a diagram of an example scenario in accordance with an implementation of the present disclosure.

FIG. 10 is a diagram of an example design in accordance with an implementation of the present disclosure.

FIG. 11 is a diagram of an example scenario in accordance with an implementation of the present disclosure.

FIG. 12 is a diagram of an example scenario in accordance with an implementation of the present disclosure.

FIG. 13 is a block diagram of an example communication system in accordance with an implementation of the present disclosure.

FIG. 14 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to 4×LTF sequence design for wide bandwidths in wireless communications. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular RU (rRU) refers to a RU with tones that are continuous (e.g., adjacent to one another) and not interleaved, interlaced or otherwise distributed. Moreover, a 26-tone regular RU may be interchangeably denoted as RU26 (or rRU26), a 52-tone regular RU may be interchangeably denoted as RU52 (or rRU52), a 106-tone regular RU may be interchangeably denoted as RU106 (or rRU106), a 242-tone regular RU may be interchangeably denoted as RU242 (or rRU242), and so on. Moreover, an aggregate (26+52)-tone regular multi-RU (MRU) may be interchangeably denoted as MRU78 (or rMRU78), an aggregate (26+106)-tone regular MRU may be interchangeably denoted as MRU132 (or rMRU132), and so on.

Since the above examples are merely illustrative examples and not an exhaustive listing of all possibilities, the same applies to regular RUs, distributed-tone RUs, MRUs, and distributed-tone MRUs of different sizes (or different number of tones). It is also noteworthy that, in the present disclosure, a bandwidth of 20 MHz may be interchangeably denoted as BW20 or BW20M, a bandwidth of 40 MHz may be interchangeably denoted as BW40 or BW40M, a bandwidth of 80 MHz may be interchangeably denoted as BW80 or BW80M, a bandwidth of 160 MHz may be interchangeably denoted as BW160 or BW160M, a bandwidth of 240 MHz may be interchangeably denoted as BW240 or BW240M, a bandwidth of 320 MHz may be interchangeably denoted as BW320 or BW320M, a bandwidth of 480 MHz may be interchangeably denoted as BW480 or BW480M, and a bandwidth of 640 MHz may be interchangeably denoted as BW640 or BW640M.

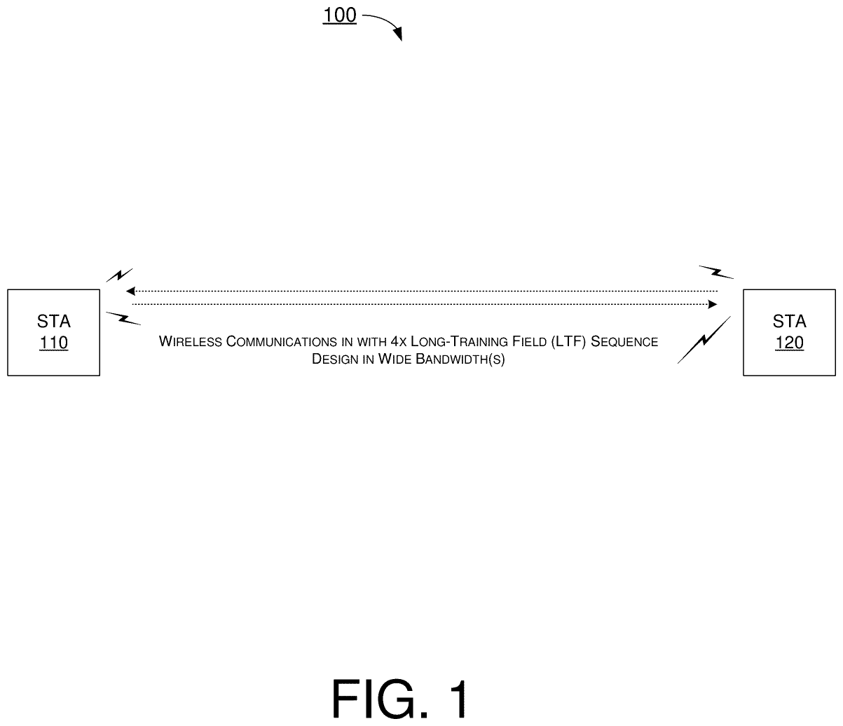

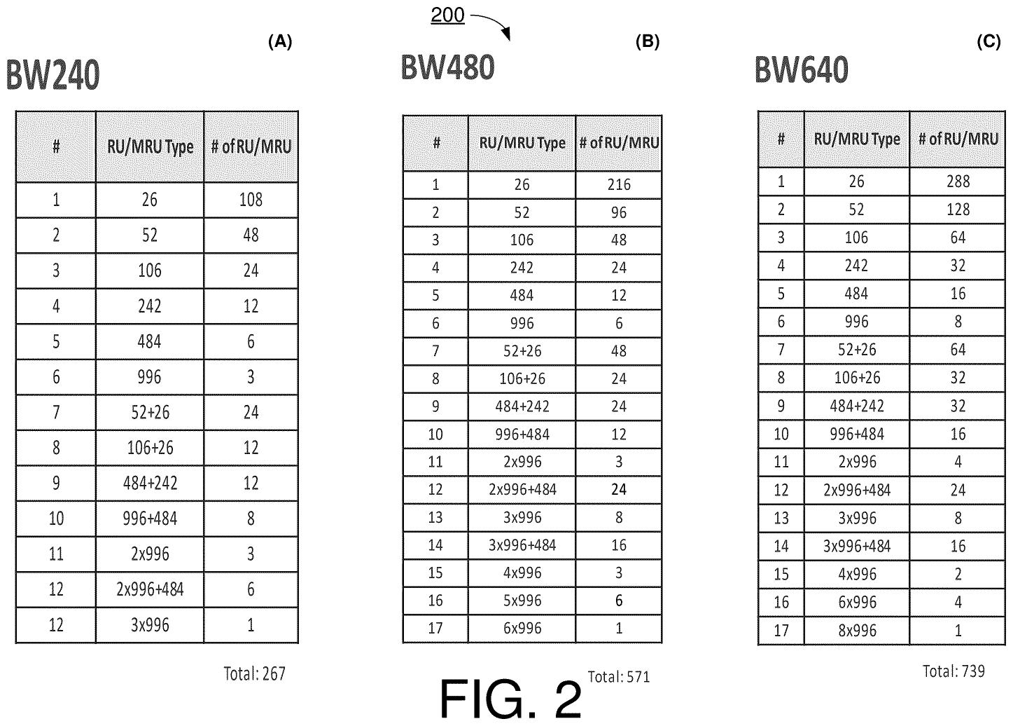

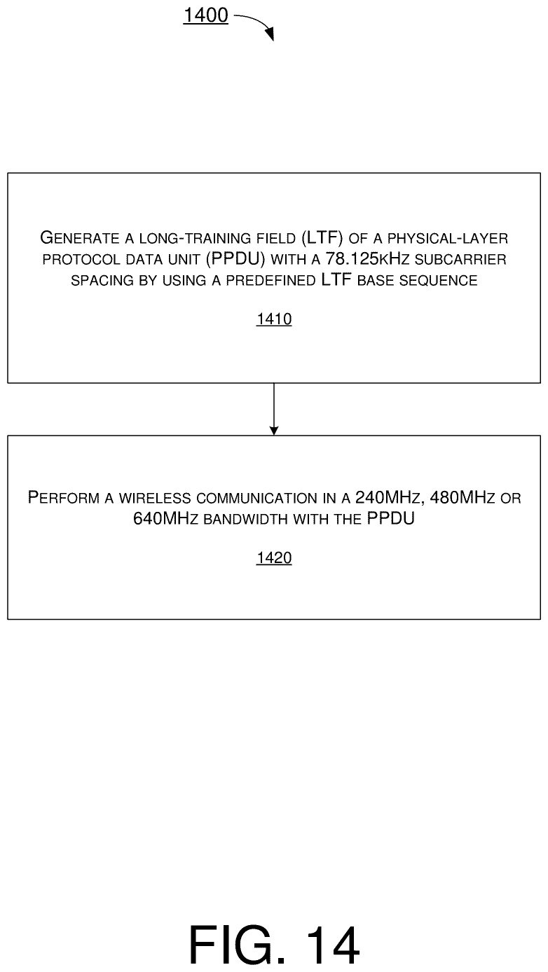

FIG. 1 illustrates an example network environment 100 in which various solutions and schemes in accordance with the present disclosure may be implemented. FIG. 2˜FIG. 14 illustrate examples of implementation of various proposed schemes in network environment 100 in accordance with the present disclosure. The following description of various proposed schemes is provided with reference to FIG. 1˜FIG. 14.

Referring to FIG. 1, network environment 100 may involve at least a station (STA) 110 communicating wirelessly with a STA 120. Either of STA 110 and STA 120 may function as an access point (AP) STA or, alternatively, a non-AP STA. In some cases, STA 110 and STA 120 may be associated with a basic service set (BSS) in accordance with one or more IEEE 802.11 standards (e.g., IEEE 802.11be and/or future-developed standards). Each of STA 110 and STA 120 may be configured to communicate with each other by utilizing the 4×LTF sequence design for wide bandwidths in wireless communications in accordance with various proposed schemes described below. That is, either or both of STA 110 and STA 120 may function as a “user” in the proposed schemes and examples described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example scenario 200 in accordance with an implementation of the present disclosure. Scenario 200 may pertain to RU/MRU for BW240, BW480 and BW640 considered in LTF PAPR evaluations. Part (A) of FIG. 2 shows a list of RU/MUR types (in terms of number of tones in a given RU/MRU) and respective numbers of RU/MRUs transmittable in BW240. Part (B) of FIG. 2 shows a list of RU/MUR types (in terms of number of tones in a given RU/MRU) and respective numbers of RU/MRUs transmittable in BW480. Part (C) of FIG. 2 shows a list of RU/MUR types (in terms of number of tones in a given RU/MRU) and respective numbers of RU/MRUs transmittable in BW640.

Under a proposed scheme in accordance with the present disclosure, there may be several options with respect to 4×ultra-high reliability (UHR) LTF (UHR-LTF) design for wide bandwidths such as BW240, BW480 and BW640. In a first option (Option-1), a 80 MHz bandwidth subblock base sequence and the optimized coefficients under IEEE 802.11be may be utilized to construct a LTF sequence for the wide bandwidths of 240 MHz, 480 MHz and 640 MHz for next-generation WiFi. In a second option (Option-2), a 160 MHz bandwidth extremely-high throughput (EHT) LTF (EHT-LTF) sequence under IEEE 802.11be may be utilized to construct a LTF sequence for the wide bandwidths of 480 MHz and 640 MHz for next-generation WiFi. Moreover, a 160 MHz bandwidth EHT-LTF sequence and a 80 MHz bandwidth EHT-LTF sequence under IEEE 802.11be may be utilized to construct a LTF sequence for the wide bandwidth of 240 MHz. In a third option (Option-3), a subblock base sequence and the optimized coefficients for 80 MHz bandwidth under IEEE 802.11ax may be utilized to construct a LTF sequence for the wide bandwidths of 240 MHz, 480 MHz and 640 MHz for next-generation WiFi. In a first option (Option-4), a 160 MHz bandwidth High-Efficiency (HE)-LTF sequence under IEEE 802.11ax may be utilized to construct a LTF sequence for the wide bandwidths of 480 MHz and 640 MHz for next-generation WiFi. Moreover, a 160 MHz bandwidth HE-LTF sequence and a 80 MHz bandwidth EHT-LTF sequence under IEEE 802.11ax may be utilized to construct a LTF sequence for the wide bandwidth of 240 MHz. In the present disclosure, the term “4×” refers to four times the frequency of tones in the LTF relative to a legacy LTF. In other words, the subcarrier spacing in a 4×LTF sequence under the proposed schemes may be 78.125 kHz (as opposed to 312.5 kHz for legacy LTF).

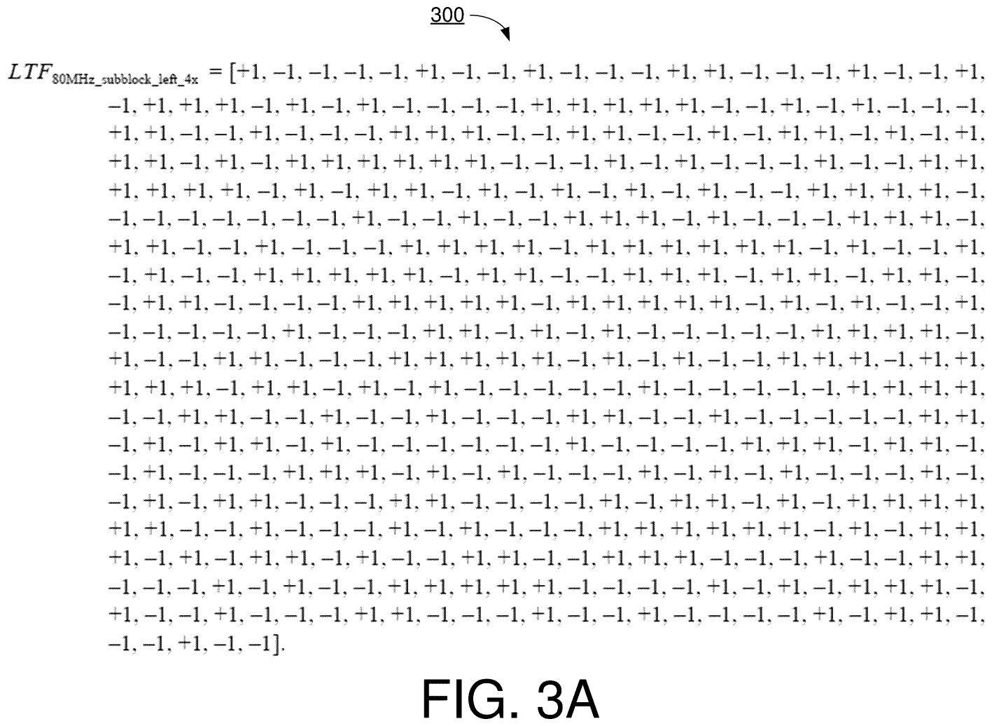

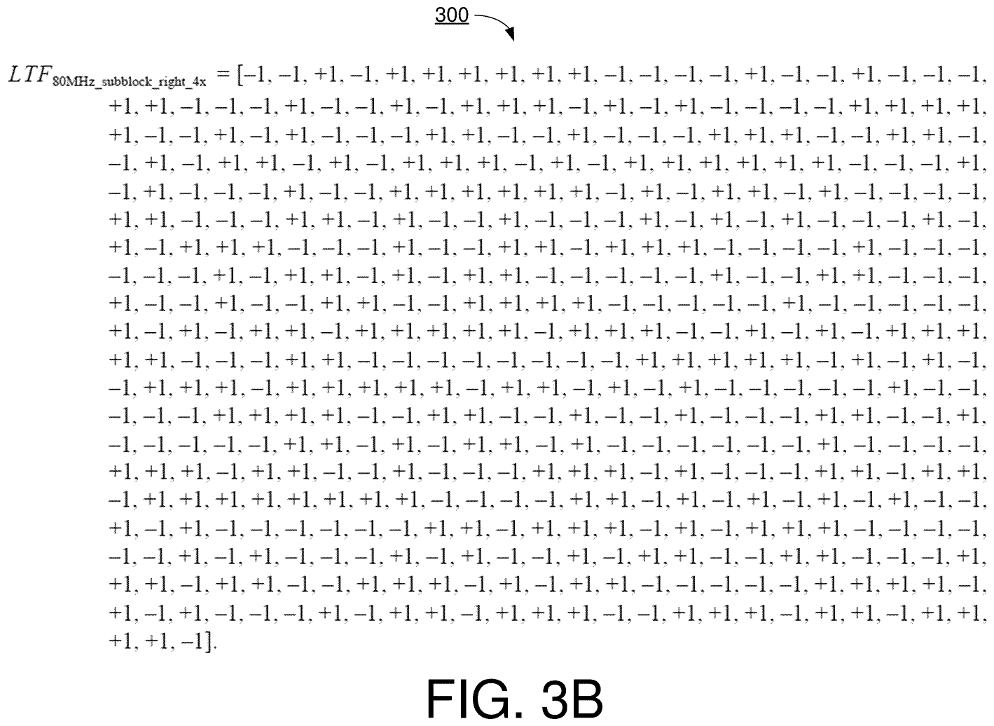

Accordingly, in each of Option-1, Option-2, Option-3 and Option-4, the a 4×UHR-LTF sequence of a physical-layer protocol data unit (PPDU) for wireless communications in wide bandwidths of BW240, BW480 and BW640 may be generated or otherwise constructed using a predefined LTF base sequence (e.g., an IEEE 802.11be 80 MHz subblock base sequence for LTF in Option-1, an IEEE 802.11be 160 MHz EHT-LTF sequence and an IEEE 802.11be 80 MHz EHT-LTF sequence in Option-2, an IEEE 802.11ax 80 MHz subblock base sequence in Option-3, and an IEEE 802.11ax 160 MHz HE-LTF sequence and an IEEE 802.11ax 80 MHz HE-LTF sequence in Option-4). FIG. 3A and FIG. 3B illustrates an example design 300 under the proposed scheme. Specifically, FIG. 3A shows the left half of a predefined LTF base sequence used in Option-1 and FIG. 3B shows the right half of the predefined LTF base sequence used in Option-1. Referring to FIG. 3A and FIG. 3B, the predefined LTF base sequence used in Option-1 may be an IEEE 802.11be 80 MHz subblock base sequence for LTF. The left half of the IEEE 802.11be 80 MHz subblock base sequence for LTF with a 78.125 kHz subcarrier spacing is herein interchangeably denoted as “LTF_{80MHz_subblock_left_4×}”, and the right half of the IEEE 802.11be 80 MHz subblock base sequence for LTF with a 78.125 kHz subcarrier spacing is herein interchangeably denoted as “LTF_{80MHz_subblock_right_4×}.”

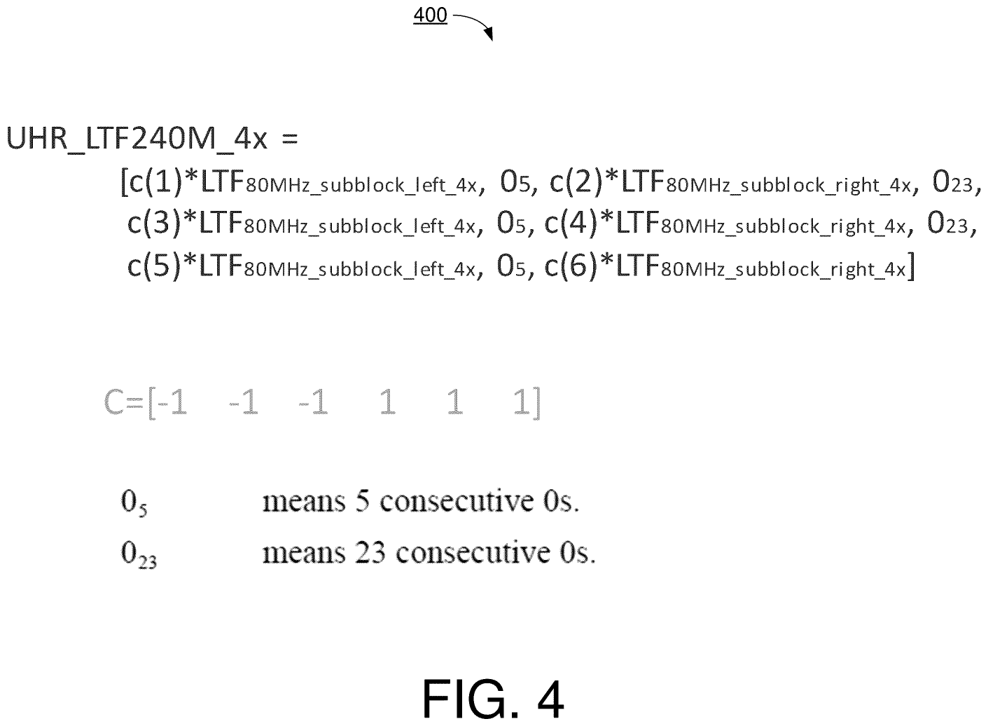

FIG. 4 illustrates an example design 400 in accordance with an implementation of the present disclosure. Under the proposed scheme, a 4×UHR-LTF sequence for BW240 (herein interchangeably denoted as “UHR-LTF240M_4×”) under Option-1 may be expressed as: UHR-LTF240M_4×=[c(1)*LTF_{80MHz_sublock_left_4×}, 0₅, c(2)*LTF_{80MHz_subblock_right_4×}, 0₂₃, c(3)*LTF_{80MHz_subblock_left_4×}, 0₅, c(4)*LTF_{80MHz_subblock_right_4×}, 0₂₃, c(5)*LTF_{80MHz_subblock_left_4×}, 0₅, c(6)*LTF_{80MHz_subblock_right_4×}]. Here, the vector C of a combination of optimized coefficients=[c(1) c(2) c(3) c(4) c(5) c(6)]=[−1 −1 −1 1 1 1], “0₅” denotes five consecutive 0s, and “0₂₃” denotes twenty-three consecutive 0s. The optimized coefficients are chosen to achieve the minimum PAPR of LTF and data tones over all RU and MRU types/sizes in BW240 with the 4×UHR-LTF sequence under the proposed scheme.

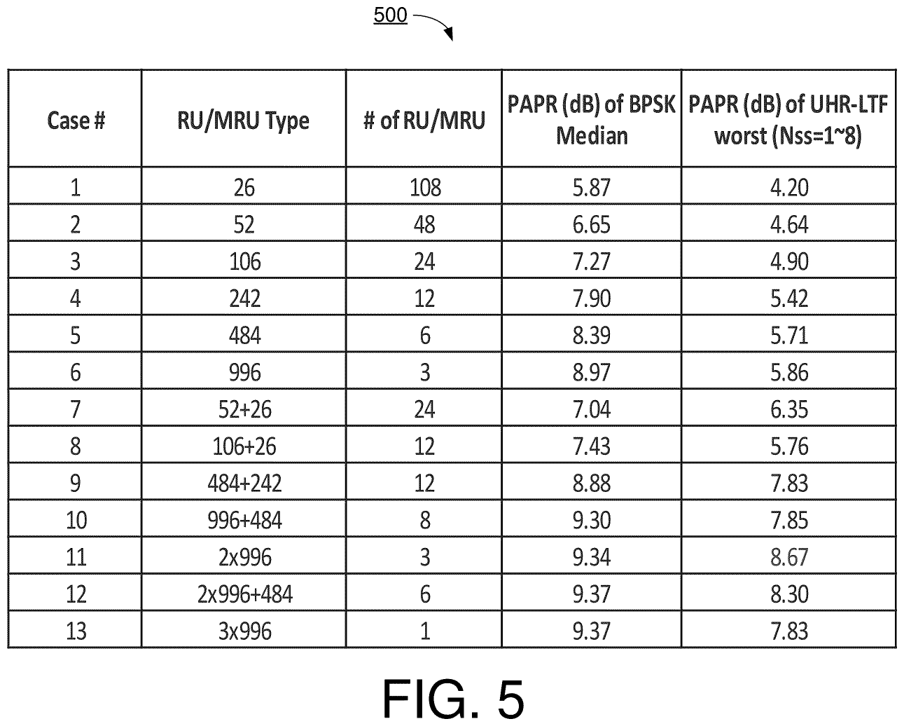

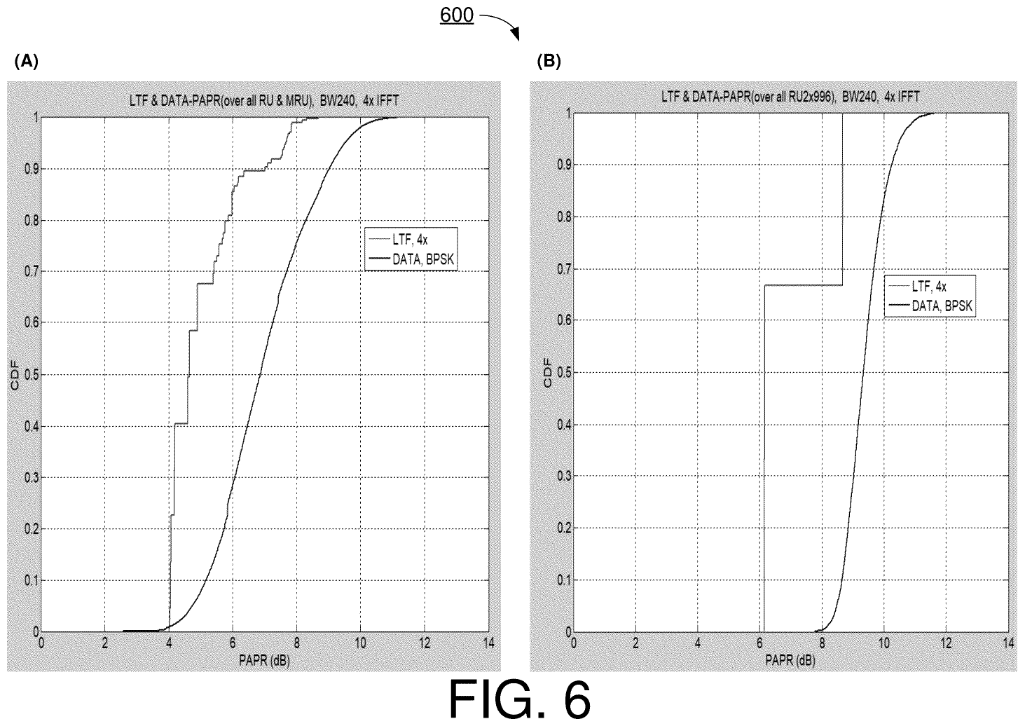

FIG. 5 illustrates an example scenario 500 under the proposed scheme. Scenario 500 may pertain to PAPR of BW240 with the 4×UHR-LTF sequence under the proposed scheme. The right-most column in the table in FIG. 5 shows the worst PAPR (in dB) of UHR-LTF for a number of spatial stream (N_{SS}) ranging from one to eight for various combinations of dRU/MRU types and various of RU/MRU sizes. FIG. 6 illustrates an example scenario 600 under the proposed scheme. Scenario 600 may pertain to PAPR of LTF and data tones over all RU and MRU types/sizes in BW240 (part (A) of FIG. 6) and the worst-case PAPR of LTF and data tones over MRU (2×996) in BW240 (part (B) of FIG. 6). In the graph shown in each of part (A) and part (B) of FIG. 6, the curve on the left side pertains to the PAPR in units of dB of LTF tones while the curve on the right side pertains to the PAPR in units of dB of data tones modulated using binary phase-shift keying (BPSK) modulation.

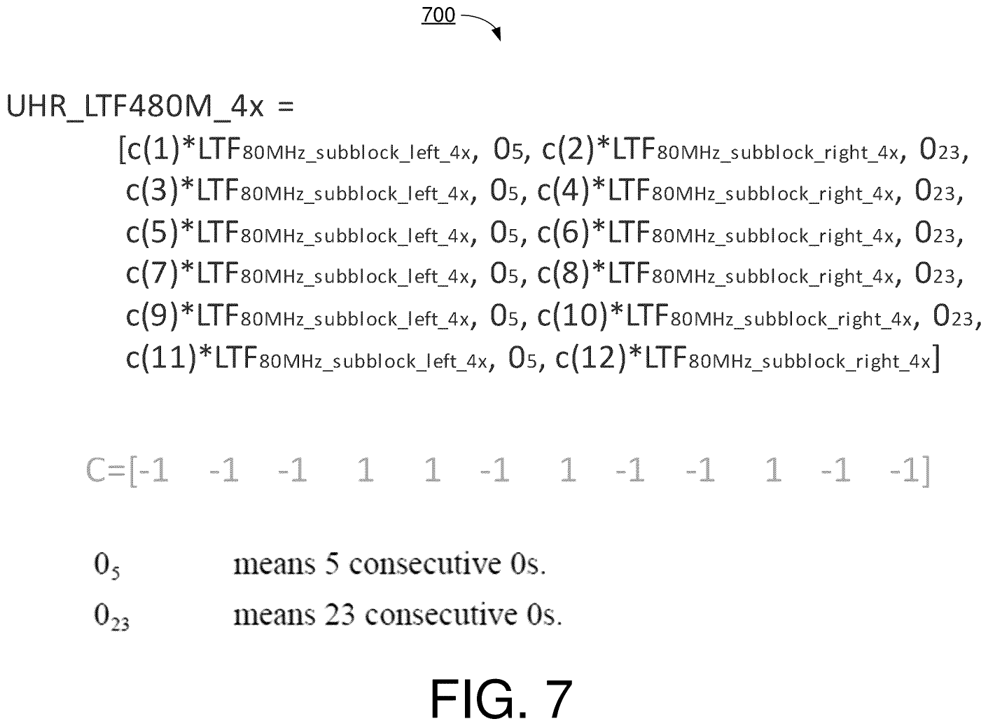

FIG. 7 illustrates an example design 700 in accordance with an implementation of the present disclosure. Under the proposed scheme, a 4×UHR-LTF sequence for BW480 (herein interchangeably denoted as “UHR-LTF480M_4×”) under Option-1 may be expressed as: UHR-LTF480M_4×=[c(1)*LTF_{80MHz_sublock_left_4×}, 0₅, c(2)*LTF_{80MHz_subblock_right_4×}, 0₂₃, c(3)*LTF_{80MHz_subblock_left_4×}, 0₅, c(4)*LTF_{80MHz_subblock_right_4×}, 0₂₃, c(5)*LTF_{80MHz_subblock_left_4×}, 0₅, c(6)*LTF_{80MHz_subblock_right_4×}, 0₂₃, c(7)*LTF_{80MHz_subblock_left_4×}, 0₅, c(8)*LTF_{80MHz_subblock_right_4×}, 0₂₃, c(9)*LTF_{80MHz_subblock_left_4×}, 0₅, c(10)*LTF_{80MHz_subblock_right_4×}, 0₂₃, c(11) LTF_{80MHz_sublock_left_4×}, 0₅, c(12)*LTF_{80MHz_subblock_right_4×}]. Here, the vector C of a combination of optimized coefficients=[c(1) c(2) c(3) c(4) c(5) c(6) c(7) c(8) c(9) c(10) c(11) c(12)]=[−1 −1 −1 1 1 −1 −1 1 −1 −1], “0₅” denotes five consecutive 0s, and “0₂₃” denotes twenty-three consecutive 0s. The optimized coefficients are chosen to achieve the minimum PAPR of LTF and data tones over all RU and MRU types/sizes in BW480 with the 4×UHR-LTF sequence under the proposed scheme.

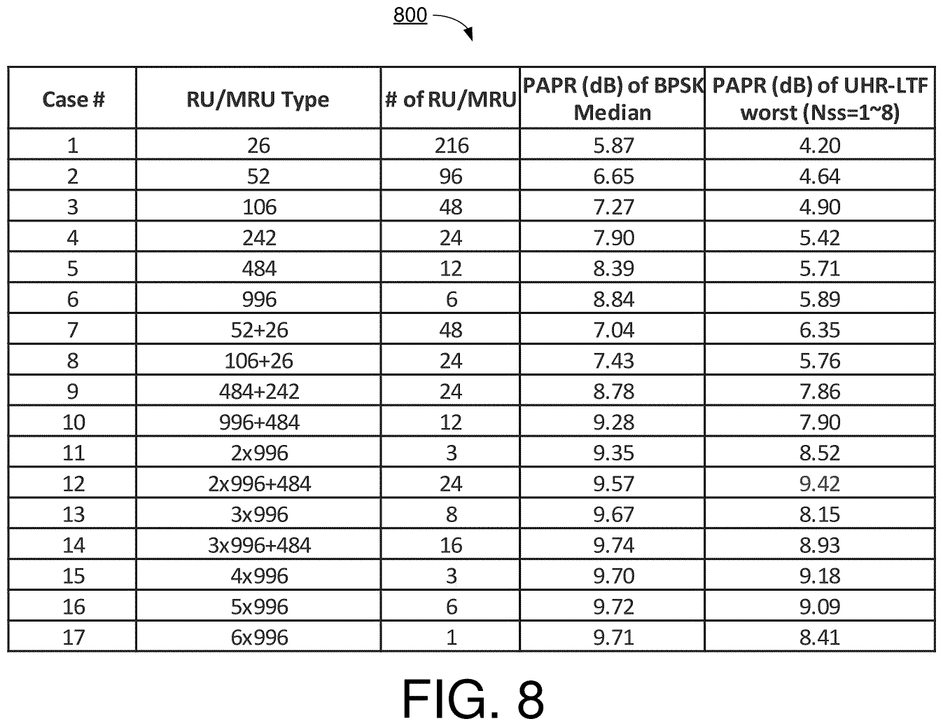

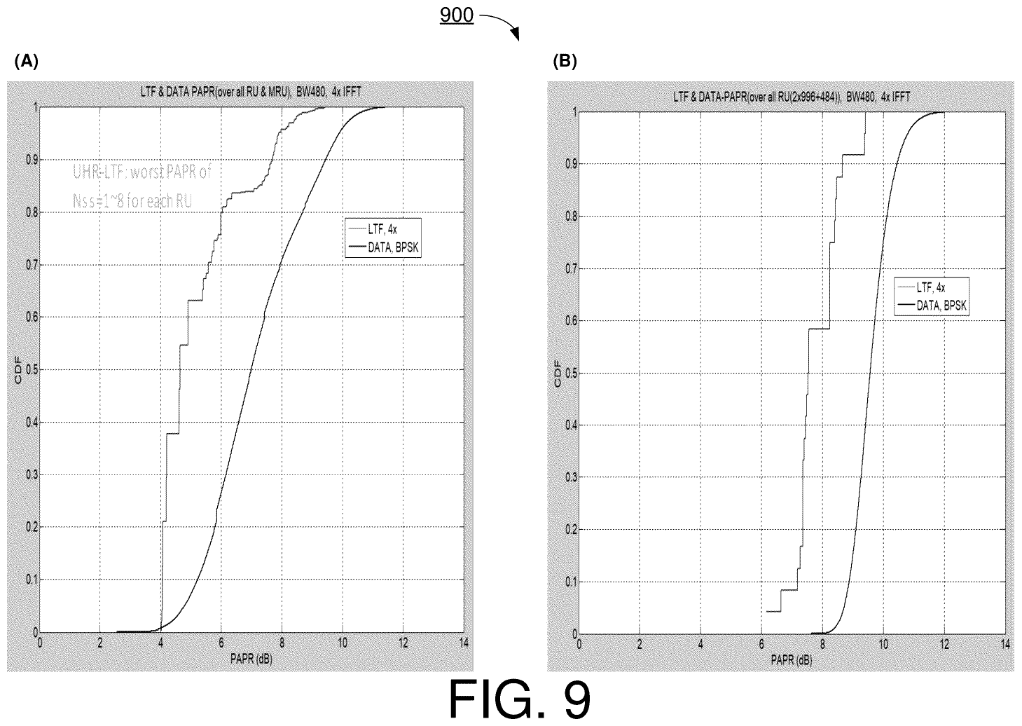

FIG. 8 illustrates an example scenario 800 under the proposed scheme. Scenario 800 may pertain to PAPR of BW480 with the 4×UHR-LTF sequence under the proposed scheme. The right-most column in the table in FIG. 8 shows the worst PAPR (in dB) of UHR-LTF for N_{SS} ranging from one to eight for various combinations of dRU/MRU types and various of RU/MRU sizes. FIG. 9 illustrates an example scenario 900 under the proposed scheme. Scenario 900 may pertain to PAPR of LTF and data tones over all RU and MRU types/sizes in BW480 (part (A) of FIG. 9) and the worst-case PAPR of LTF and data tones over MRU (2×996+484) in BW480 (part (B) of FIG. 9). In the graph shown in each of part (A) and part (B) of FIG. 9, the curve on the left side pertains to the PAPR of LTF tones while the curve on the right side pertains to the PAPR of data tones modulated using BPSK modulation.

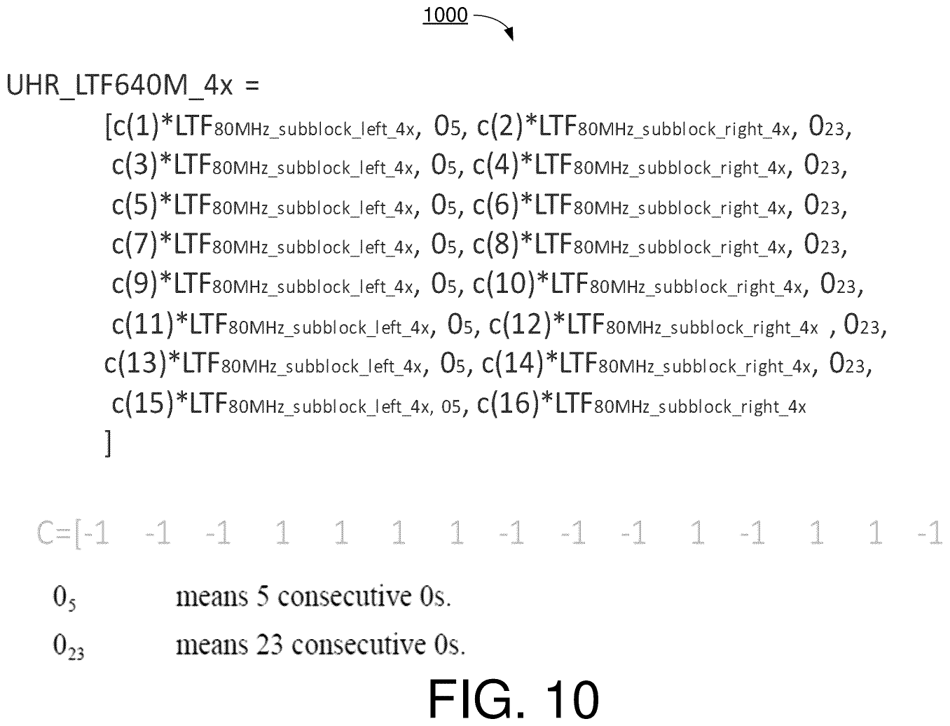

FIG. 10 illustrates an example design 1000 in accordance with an implementation of the present disclosure. Under the proposed scheme, a 4×UHR-LTF sequence for BW640 (herein interchangeably denoted as “UHR-LTF640M_4×”) under Option-1 may be expressed as: UHR-LTF640M_4×=[c(1)*LTF_{80MHz_subblock_left_4×}, 0₅, c(2)*LTF_{80MHz_subblock_right_4×}, 0₂₃, c(3)*LTF_{80MHz_subblock_left_4×}, 0₅, c(4)*LTF_{80MHz_sublock_right_4×}, 0₂₃, c(5)*LTF_{80MHz_sublock_left_4×}, 0₅, c(6)*LTF_{80MHz_subblock_right_4×}, 0₂₃, c(7)*LTF_{80MHz_subblock_left_4×}, 0₅, c(8)*LTF_{80MHz_subblock_right_4×}, 0₂₃, LTF_{80MHz_subblock_right_4×}, 0₂₃, c(11)*LTF_{80MHz_subblock_left_4×}, 0₅, c(12)*LTF80MH/subblock right 4×, 0₂₃, c(13)*LTF_{80MHz_subblock_left_4×}, 0₅, c(14)*LTF_{80MHz_subblock_right_4×}, 0₂₃, c(15)*LTF_{80MHz_subblock_left_4×}, 0₅, c(16)*LTF_{80MHz_subblock_right_4×}]. Here, the vector C of a combination of optimized coefficients=[c(1) c(2) c(3) c(4) c(5) c(6) c(7) c(8) c(9) c(10) c(11) c(12) c(13) c(14) c(15) c(16)]=[−1 −1 −1 1 1 1 1 −1 −1 −1 1 −1 1 1 −1 1], “0₅” denotes five consecutive 0s, and “0₂₃” denotes twenty-three consecutive 0s. The optimized coefficients are chosen to achieve the minimum PAPR of LTF and data tones over all RU and MRU types/sizes in BW640 with the 4×UHR-LTF sequence under the proposed scheme.

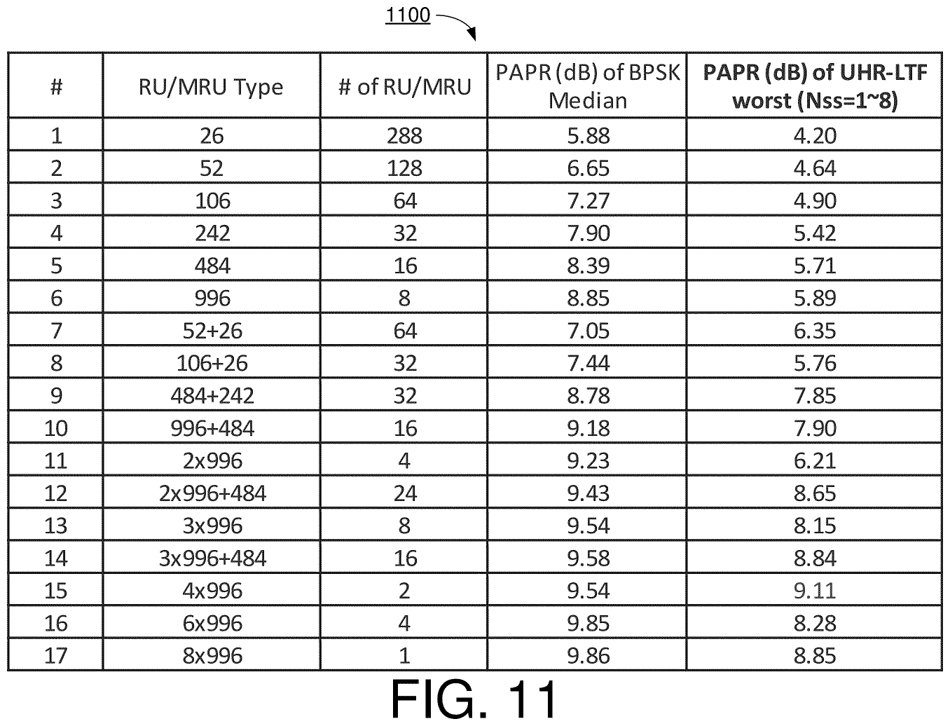

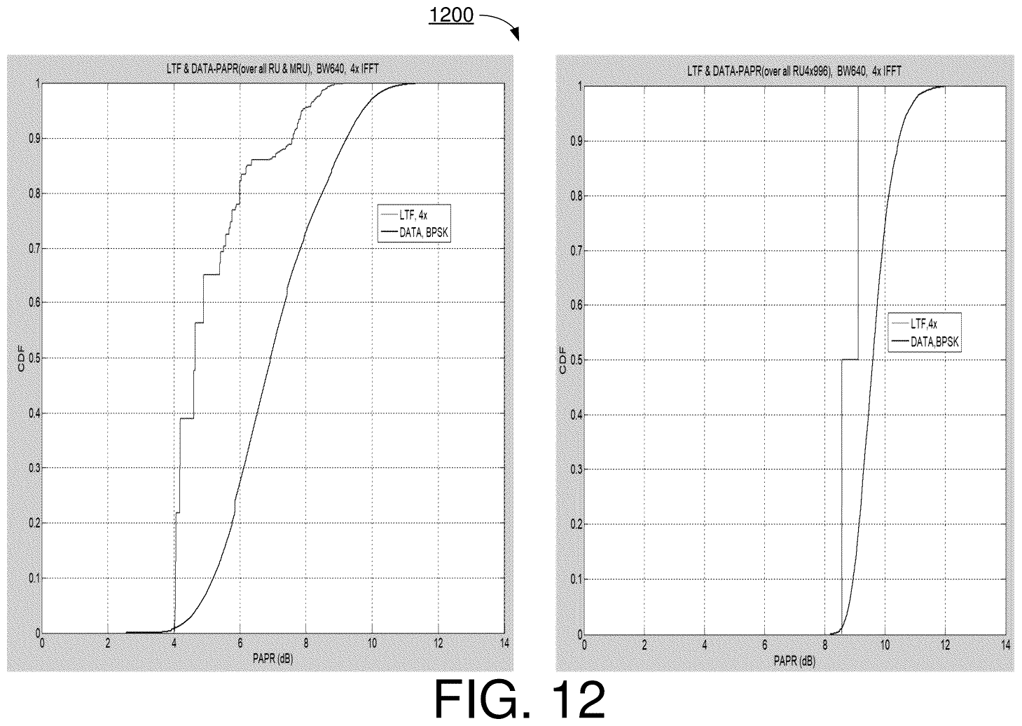

FIG. 11 illustrates an example scenario 1100 under the proposed scheme. Scenario 1100 may pertain to PAPR of BW640 with the 4×UHR-LTF sequence under the proposed scheme. The right-most column in the table in FIG. 11 shows the worst PAPR (in dB) of UHR-LTF for N_{SS} ranging from one to eight for various combinations of dRU/MRU types and various of RU/MRU sizes. FIG. 12 illustrates an example scenario 1200 under the proposed scheme. Scenario 1200 may pertain to PAPR of LTF and data tones over all RU and MRU types/sizes in BW640 (left side of FIG. 12) and the worst-case PAPR of LTF and data tones over MRU (4×996) in BW640 (right side of FIG. 12).

### Illustrative Implementations

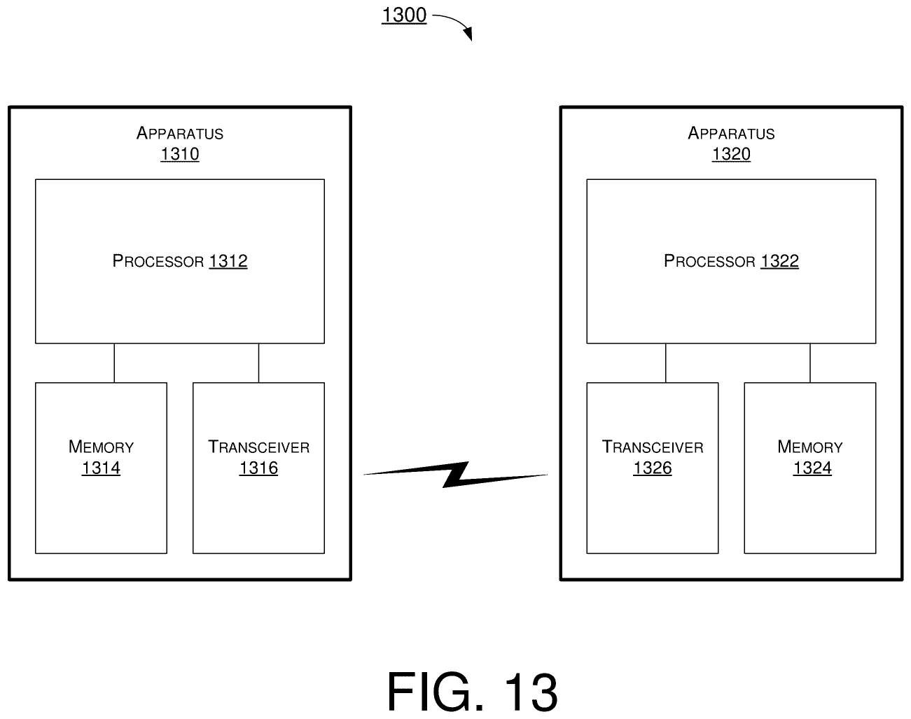

FIG. 13 illustrates an example system 1300 having at least an example apparatus 1310 and an example apparatus 1320 in accordance with an implementation of the present disclosure. Each of apparatus 1310 and apparatus 1320 may perform various functions to implement schemes, techniques, processes and methods described herein pertaining to 4×LTF sequence design for wide bandwidths in wireless communications, including the various schemes described above with respect to various proposed designs, concepts, schemes, systems and methods described above as well as processes described below. For instance, apparatus 1310 may be an example implementation of communication entity 110, and apparatus 1320 may be an example implementation of communication entity 120.

Each of apparatus 1310 and apparatus 1320 may be a part of an electronic apparatus, which may be a STA or an AP, such as a portable or mobile apparatus, a wearable apparatus, a wireless communication apparatus or a computing apparatus. For instance, each of apparatus 1310 and apparatus 1320 may be implemented in a smartphone, a smart watch, a personal digital assistant, a digital camera, or a computing equipment such as a tablet computer, a laptop computer or a notebook computer. Each of apparatus 1310 and apparatus 1320 may also be a part of a machine type apparatus, which may be an IoT apparatus such as an immobile or a stationary apparatus, a home apparatus, a wire communication apparatus or a computing apparatus. For instance, each of apparatus 1310 and apparatus 1320 may be implemented in a smart thermostat, a smart fridge, a smart door lock, a wireless speaker or a home control center. When implemented in or as a network apparatus, apparatus 1310 and/or apparatus 1320 may be implemented in a network node, such as an AP in a WLAN.

In some implementations, each of apparatus 1310 and apparatus 1320 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1310 and apparatus 1320 may be implemented in or as a STA or an AP. Each of apparatus 1310 and apparatus 1320 may include at least some of those components shown in FIG. 13 such as a processor 1312 and a processor 1322, respectively, for example. Each of apparatus 1310 and apparatus 1320 may further include one or more other components not pertinent to the proposed scheme of the present disclosure (e.g., internal power supply, display device and/or user interface device), and, thus, such component(s) of apparatus 1310 and apparatus 1320 are neither shown in FIG. 13 nor described below in the interest of simplicity and brevity.

In one aspect, each of processor 1312 and processor 1322 may be implemented in the form of one or more single-core processors, one or more multi-core processors, one or more RISC processors or one or more CISC processors. That is, even though a singular term “a processor” is used herein to refer to processor 1312 and processor 1322, each of processor 1312 and processor 1322 may include multiple processors in some implementations and a single processor in other implementations in accordance with the present disclosure. In another aspect, each of processor 1312 and processor 1322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1312 and processor 1322 is a special-purpose machine specifically designed, arranged and configured to perform specific tasks including those pertaining to 4×LTF sequence design for wide bandwidths in wireless communications in accordance with various implementations of the present disclosure. For instance, each of processor 1312 and processor 1322 may be configured with hardware components, or circuitry, implementing one, some or all of the examples described and illustrated herein.

In some implementations, apparatus 1310 may also include a transceiver 1316 coupled to processor 1312. Transceiver 1316 may be capable of wirelessly transmitting and receiving data. In some implementations, apparatus 1320 may also include a transceiver 1326 coupled to processor 1322. Transceiver 1326 may include a transceiver capable of wirelessly transmitting and receiving data.

In some implementations, apparatus 1310 may further include a memory 1314 coupled to processor 1312 and capable of being accessed by processor 1312 and storing data therein. In some implementations, apparatus 1320 may further include a memory 1324 coupled to processor 1322 and capable of being accessed by processor 1322 and storing data therein. Each of memory 1314 and memory 1324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1314 and memory 1324 may include a type of read-only memory (ROM) such as mask ROM, programmable ROM (PROM), erasable programmable ROM (EPROM) and/or electrically erasable programmable ROM (EEPROM). Alternatively, or additionally, each of memory 1314 and memory 1324 may include a type of non-volatile random-access memory (NVRAM) such as flash memory, solid-state memory, ferroelectric RAM (FeRAM), magnetoresistive RAM (MRAM) and/or phase-change memory.

Each of apparatus 1310 and apparatus 1320 may be a communication entity capable of communicating with each other using various proposed schemes in accordance with the present disclosure. For illustrative purposes and without limitation, a description of capabilities of apparatus 1310, as communication entity 110, and apparatus 1320, as communication entity 120, is provided below in the context of example process 1400. It is noteworthy that, although the example implementations described below are provided in the context of WLAN, the same may be implemented in other types of networks. Thus, although the following description of example implementations pertains to a scenario in which apparatus 1310 functions as a transmitting device and apparatus 1320 functions as a receiving device, the same is also applicable to another scenario in which apparatus 1310 functions as a receiving device and apparatus 1320 functions as a transmitting device.

### Illustrative Processes

FIG. 14 illustrates an example process 1400 in accordance with an implementation of the present disclosure. Process 1400 may represent an aspect of implementing various proposed designs, concepts, schemes, systems and methods described above. More specifically, process 1400 may represent an aspect of the proposed concepts and schemes pertaining to 4×LTF sequence design for wide bandwidths in wireless communications in accordance with the present disclosure. Process 1400 may include one or more operations, actions, or functions as illustrated by one or more of blocks 1410 and 1420. Although illustrated as discrete blocks, various blocks of process 1400 may be divided into additional blocks, combined into fewer blocks, or eliminated, depending on the desired implementation. Moreover, the blocks/sub-blocks of process 1400 may be executed in the order shown in FIG. 14 or, alternatively in a different order. Furthermore, one or more of the blocks/sub-blocks of process 1400 may be executed repeatedly or iteratively. Process 1400 may be implemented by or in apparatus 1310 and apparatus 1320 as well as any variations thereof. Solely for illustrative purposes and without limiting the scope, process 1400 is described below in the context of apparatus 1310 as communication entity 110 (e.g., a transmitting device whether a STA or an AP) and apparatus 1320 as communication entity 120 (e.g., a receiving device whether a STA or an AP) of a wireless network such as a WLAN in accordance with one or more of IEEE 802.11 standards. Process 1400 may begin at block 1410.

At 1410, process 1400 may involve processor 1312 of apparatus 1310 generating an LTF of a PPDU with a 78.125 kHz subcarrier spacing by using a predefined LTF base sequence. Process 1400 may proceed from 1410 to 1420.

At 1420, process 1400 may involve processor 1312 performing, via transceiver 1316, a wireless communication (e.g., with apparatus 1320) in a 240 MHz, 480 MHz or 640 MHz bandwidth with the PPDU.

In some implementations (Option-1), in generating the LTF, process 1400 may involve processor 1312 generating the LTF of the PPDU using an IEEE 802.11be 80 MHz subblock base sequence such that the LTF is used in the wireless communication in the 240 MHz, 480 MHz or 640 MHz bandwidth.

Moreover, under Option-1, in generating the LTF, process 1400 may further involve processor 1312 generating the LTF of the PPDU using a combination of optimized coefficients such that the LTF is used in the wireless communication in the 240 MHz bandwidth. Specifically: (i) the LTF=[c(1)*LTF_{80MHz_subblock_left_4×}, 0₅, c(2)*LTF_{80MHz_subblock_right_4×}, 0₂₃, c(3)*LTF_{80MHz_sublock_left_4×}, 0₅, c(4)*LTF_{80MHz_sublock_right_4×}, 0₂₃, c(5)*LTF_{80MHz_sublock_left_4×}, 0₅, c(6)*LTF_{80MHz_subblock_right_4×}], (ii) the combination of optimized coefficients=[c(1) c(2) c(3) c(4) c(5) c(6)]=[−1 −1 −1 1 1 1], (iii) LTF_{80MHz_subblock_left_4×} denotes a left half of the IEEE 802.11be 80 MHz subblock base sequence with the 78.125 kHz subcarrier spacing, (iv) LTF_{80MHz_subblock_right_4×} denotes a right half of the IEEE 802.11be 80 MHz subblock base sequence with the 78.125 kHz subcarrier spacing, (v) 0₅ denotes five consecutive 0s, and (vi) 0₂₃ denotes twenty-three consecutive 0s.

Alternatively, under Option-1, in generating the LTF, process 1400 may further involve processor 1312 generating the LTF of the PPDU using a combination of optimized coefficients such that the LTF is used in the wireless communication in the 480 MHz bandwidth. Specifically: (i) LTF=[c(1)*LTF_{80MHz_subblock_left_4×}, 0₅, c(2)*LTF_{80MHz_subblock_right_4×}, 0₂₃, c(3)*LTF_{80MHz_subblock_left_4×}, 0₅, c(4)*LTF_{80MHz_subblock_right_4×}, 0₂₃, c(5)*LTF_{80MHz_subblock_left_4×}, 0₅, c(6)*LTF_{80MHz_subblock_right_4×}, 0₂₃, c(7)*LTF_{80MHz_subblock_left_4×}, 0₅, c(8)*LTF_{80MHz_subblock_right_4×}, 0₂₃, c(9)*LTF_{80MHz_subblock_left_4×}, 0₅, c(10)*LTF_{80MHz_subblock_right_4×}, 0₂₃, c(11)*LTF_{80MHz_subblock_left_4×}, 0₅, c(12)*LTF_{80MHz_subblock_right_4×}], (ii) the combination of optimized coefficients=[c(1) c(2) c(3) c(4) c(5) c(6) c(7) c(8) c(9) c(10) c(11) c(12)]=[−1 −1 −1 1 1 −1 1 −1 −1 1 −1 −1], (iii) LTF_{80MHz_subblock_left_4×} denotes a left half of the IEEE 802.11be 80 MHz subblock base sequence with the 78.125 kHz subcarrier spacing, (iv) LTF_{80MHz_subblock_right_4×} denotes a right half of the IEEE 802.11be 80 MHz subblock base sequence with the 78.125 kHz subcarrier spacing, (v) 0₅ denotes five consecutive 0s, and (vi) 0₂₃ denotes twenty-three consecutive 0s.

Alternatively, under Option-1, in generating the LTF, process 1400 may further involve processor 1312 generating the LTF of the PPDU using a combination of optimized coefficients such that the LTF is used in the wireless communication in the 640 MHz bandwidth. Specifically: (i) LTF=[c(1)*LTF_{80MHz_subblock_left_4×}, 0₅, c(2)*LTF_{80MHz_subblock_right_4×}, 0₂₃, c(3)*LTF_{80MHz_subblock_left_4×}, 0₅, c(4)*LTF_{80MHz_subblock_right_4×}, 0₂₃, c(5)*LTF_{80MHz_subblock_left_4×}, 0₅, c(6)*LTF_{80MHz_subblock_right_4×}, 0₂₃, c(7)*LTF_{80MHz_subblock_left_4×}, 0₅, c(8)*LTF_{80MHz_subblock_right_4×}, 0₂₃, c(9)*LTF_{80MHz_subblock_left_4×}, 0₅, c(10)*LTF_{80MHz_subblock_right_4×}, 0₂₃, c(11)*LTF_{80MHz_subblock_left_4×}, 0₅, c(12)*LTF_{80MHz_subblock_right_4×}, 0₂₃, c(13)*LTF_{80MHz_subblock_left_4×}, 0₅, c(14)*LTF_{80MHz_subblock_right_4×}, 0₂₃, c(15)*LTF_{80MHz_subblock_left_4×}, 0₅, c(16) LTF_{80MHz_sublock_right_4×}], (ii) the combination of optimized coefficients=[c(1) c(2) c(3) c(4) c(5) c(6) c(7) c(8) c(9) c(10) c(11) c(12) c(13) c(14) c(15) c(16)]=[−1 −1 −1 1 1 1 −1 1 −1 1 1 −1 1], (iii) LTF_{80MHz_subblock_left_4×} denotes a left half of the IEEE 802.11be 80 MHz subblock base sequence with the 78.125 kHz subcarrier spacing, (iv) LTF_{80MHz_subblock_right_4×} denotes a right half of the IEEE 802.11be 80 MHz subblock base sequence with the 78.125 kHz subcarrier spacing, (v) 0₅ denotes five consecutive 0s, and (vi) 0₂₃ denotes twenty-three consecutive 0s.

In some implementations (Option-2), in generating the LTF, process 1400 may involve processor 1312 generating the LTF of the PPDU using an IEEE 802.11be 160 MHz EHT-LTF sequence such that the LTF is used in the wireless communication in the 480 MHz or 640 MHz bandwidth.

In some implementations (Option-2), in generating the LTF, process 1400 may involve processor 1312 generating the LTF of the PPDU using an IEEE 802.11be 160 MHz EHT-LTF sequence and an IEE 802.11be 80 MHz EHT-LTF sequence such that the LTF is used in the wireless communication in the 240 MHz bandwidth.

In some implementations (Option-3), in generating the LTF, process 1400 may involve processor 1312 generating the LTF of the PPDU using an IEEE 802.11ax 80 MHz subblock base sequence such that the LTF is used in the wireless communication in the 240 MHz, 480 MHz or 640 MHz bandwidth.

In some implementations (Option-4), in generating the LTF, process 1400 may involve processor 1312 generating the LTF of the PPDU using an IEEE 802.11ax 160 MHz HE-LTF sequence such that the LTF is used in the wireless communication in the 480 MHz or 640 MHz bandwidth.

In some implementations (Option-4), in generating the LTF, process 1400 may involve processor 1312 generating the LTF of the PPDU using an IEEE 802.11ax 160 MHz HE-LTF sequence and an IEE 802.11ax 80 MHz HE-LTF sequence such that the LTF is used in the wireless communication in the 240 MHz bandwidth.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating a long-training field (LTF) of a physical-layer protocol data unit (PPDU) with a 78.125 kHz subcarrier spacing by using a predefined LTF base sequence; and
performing a wireless communication in a 240 MHz, 480 MHz or 640 MHz bandwidth with the PPDU.

2. The method of claim 1, wherein the generating of the LTF comprises generating the LTF of the PPDU using an Institute of Electrical and Electronics Engineers (IEEE) 802.11be 80 MHz subblock base sequence such that the LTF is used in the wireless communication in the 240 MHz, 480 MHz or 640 MHz bandwidth.

3. The method of claim 2, wherein the generating of the LTF further comprises generating the LTF of the PPDU using a combination of optimized coefficients such that the LTF is used in the wireless communication in the 240 MHz bandwidth, and wherein:
$$the LTF = [ c ( 1 ) * {LTF}_{80 MHz \_ subblock \_ left \_ 4 x} , {0}_{5} , c ( 2 ) * {LTF}_{80 MHz \_ subblock \_ right \_ 4 x} , {0}_{23} , c ( 3 ) * {LTF}_{80 MHz \_ subblock \_ left \_ 4 x} , {0}_{5} , c ( 4 ) * {LTF}_{80 MHz \_ subblock \_ right \_ 4 x} , {0}_{23} , c ( 5 ) * {LTF}_{80 MHz \_ subblock \_ left \_ 4 x} , {0}_{5} , c ( 6 ) * {LTF}_{80 MHz \_ subblock \_ right \_ 4 x} ] ,$$
$$the combination of optimized coefficients = [ \begin{matrix}c ( 1 ) & c ( 2 ) & c ( 3 ) & c ( 4 ) & c ( 5 ) & c ( 6 )\end{matrix} ] = [ \begin{matrix}- 1 & - 1 & - 1 & 1 & 1 & 1\end{matrix} ] ,$$
LTF_{80MHz_subblock_left_4×} denotes a left half of the IEEE 802.11be 80 MHz subblock base sequence with the 78.125 kHz subcarrier spacing,
LTF_{80MHz_subblock_right_4×} denotes a right half of the IEEE 802.11be 80 MHz subblock base sequence with the 78.125 kHz subcarrier spacing,
0₅ denotes five consecutive 0s, and
0₂₃ denotes twenty-three consecutive 0s.

4. The method of claim 2, wherein the generating of the LTF further comprises generating the LTF of the PPDU using a combination of optimized coefficients such that the LTF is used in the wireless communication in the 480 MHz bandwidth, and wherein:
$$LTF = [ c ( 1 ) * L T {F}_{80 MHz \_ subblock \_ left \_ 4 x} , {0}_{5} , c ( 2 ) * LT {F}_{80 MHz \_ subblock \_ right \_ 4 x} , {0}_{23} , c ( 3 ) * LT {F}_{80 MHz \_ subblock \_ left \_ 4 x} , {0}_{5} , c ( 4 ) * LT {F}_{80 MHz \_ subblock \_ right \_ 4 x} , {0}_{23} , c ( 5 ) * LT {F}_{80 MHz \_ subblock \_ left \_ 4 x} , {0}_{5} , c ( 6 ) * LT {F}_{80 MHz \_ subblock \_ right \_ 4 x} , {0}_{23} , c ( 7 ) * LT {F}_{80 MHz \_ subblock \_ left \_ 4 x} , {0}_{5} , c ( 8 ) * LT {F}_{80 MHz \_ subblock \_ right \_ 4 x} , {0}_{23} , c ( 9 ) * LT {F}_{80 MHz \_ subblock \_ left \_ 4 x} , {0}_{5} , c ( 10 ) * LT {F}_{80 MHz \_ subblock \_ right \_ 4 x} , {0}_{23} , c ( 11 ) * LT {F}_{80 MHz \_ subblock \_ left \_ 4 x} , {0}_{5} , c ( 12 ) * LT {F}_{80 MHz \_ subblock \_ right \_ 4 x} ] ,$$
$$the combination of optimized coefficients = [ \begin{matrix}c ( 1 ) & c ( 2 ) & c ( 3 ) & c ( 4 ) & c ( 5 ) & \begin{matrix}c ( 6 ) & c ( 7 ) & c ( 8 ) & c ( 9 ) & c ( 10 ) & c ( 11 ) & c ( 12 )\end{matrix}\end{matrix} ] = [ \begin{matrix}- 1 & - 1 & - 1 & 1 & 1 & \begin{matrix}- 1 & 1 & - 1 & - 1 & 1 & - 1 & - 1\end{matrix}\end{matrix} ] ,$$
LTF_{80MHz_subblock_left_4×} denotes a left half of the IEEE 802.11be 80 MHz subblock base sequence with the 78.125 kHz subcarrier spacing,
LTF_{80MHz_subblock_right_4×} denotes a right half of the IEEE 802.11be 80 MHz subblock base sequence with the 78.125 kHz subcarrier spacing,
0₅ denotes five consecutive 0s, and
0₂₃ denotes twenty-three consecutive 0s.

5. The method of claim 2, wherein the generating of the LTF further comprises generating the LTF of the PPDU using a combination of optimized coefficients such that the LTF is used in the wireless communication in the 640 MHz bandwidth, and wherein:
$$LTF = [ c ( 1 ) * L T {F}_{80 MHz \_ subblock \_ left \_ 4 x} , {0}_{5} , c ( 2 ) * LT {F}_{80 MHz \_ subblock \_ right \_ 4 x} , {0}_{23} , c ( 3 ) * LT {F}_{80 MHz \_ subblock \_ left \_ 4 x} , {0}_{5} , c ( 4 ) * LT {F}_{80 MHz \_ subblock \_ right \_ 4 x} , {0}_{23} , c ( 5 ) * LT {F}_{80 MHz \_ subblock \_ left \_ 4 x} , {0}_{5} , c ( 6 ) * LT {F}_{80 MHz \_ subblock \_ right \_ 4 x} , {0}_{23} , c ( 7 ) * LT {F}_{80 MHz \_ subblock \_ left \_ 4 x} , {0}_{5} , c ( 8 ) * LT {F}_{80 MHz \_ subblock \_ right \_ 4 x} , {0}_{23} , c ( 9 ) * LT {F}_{80 MHz \_ subblock \_ left \_ 4 x} , {0}_{5} , c ( 10 ) * LT {F}_{80 MHz \_ subblock \_ right \_ 4 x} , {0}_{23} , c ( 11 ) * LT {F}_{80 MHz \_ subblock \_ left \_ 4 x} , {0}_{5} , c ( 12 ) * LT {F}_{80 MHz \_ subblock \_ right \_ 4 x} , {0}_{23} , c ( 13 ) * {LTF}_{80 MHz \_ subblock \_ left \_ 4 x} , {0}_{5} , c ( 14 ) * LT {F}_{80 MHz \_ subblock \_ right \_ 4 x} , {0}_{23} , c ( 15 ) * LT {F}_{80 MHz \_ subblock \_ left \_ 4 x} , {0}_{5} , c ( 16 ) * LT {F}_{80 MHz \_ subblock \_ right \_ 4 x} ] ,$$
$$\begin{matrix}the combination of optimized coefficients = [ \begin{matrix}\begin{matrix}\begin{matrix}c ( 1 ) & c ( 2 ) & c ( 3 ) & c ( 4 ) & c ( 5 ) & c ( 6 )\end{matrix} \\ \begin{matrix}c ( 7 ) & c ( 8 ) & c ( 9 ) & c ( 10 ) & c ( 11 )\end{matrix}\end{matrix} \\ \begin{matrix}c ( 12 ) & c ( 13 ) & c ( 14 ) & c ( 15 ) & c ( 16 )\end{matrix}\end{matrix} ] \\ = [ \begin{matrix}- 1 & - 1 & - 1 & 1 & 1 & 1 & 1 & - 1 \\ - 1 & - 1 & 1 & - 1 & 1 & 1 & - 1 & 1\end{matrix} ] ,\end{matrix}$$
LTF_{80_MHz_subblock_left_4×} denotes a left half of the IEEE 802.11be 80 MHz subblock base sequence with the 78.125 kHz subcarrier spacing,
LTF_{80MHz_subblock_right_4×} denotes a right half of the IEEE 802.11be 80 MHz subblock base sequence with the 78.125 kHz subcarrier spacing,
0₅ denotes five consecutive 0s, and
0₂₃ denotes twenty-three consecutive 0s.

6. The method of claim 1, wherein the generating of the LTF comprises generating the LTF of the PPDU using an Institute of Electrical and Electronics Engineers (IEEE) 802.11be 160 MHz extremely-high throughput (EHT)-LTF sequence such that the LTF is used in the wireless communication in the 480 MHz or 640 MHz bandwidth.

7. The method of claim 1, wherein the generating of the LTF comprises generating the LTF of the PPDU using an Institute of Electrical and Electronics Engineers (IEEE) 802.11be 160 MHz extremely-high throughput (EHT)-LTF sequence and an IEE 802.11be 80 MHz EHT-LTF sequence such that the LTF is used in the wireless communication in the 240 MHz bandwidth.

8. The method of claim 1, wherein the generating of the LTF comprises generating the LTF of the PPDU using an Institute of Electrical and Electronics Engineers (IEEE) 802.11ax 80 MHz subblock base sequence such that the LTF is used in the wireless communication in the 240 MHz, 480 MHz or 640 MHz bandwidth.

9. The method of claim 1, wherein the generating of the LTF comprises generating the LTF of the PPDU using an Institute of Electrical and Electronics Engineers (IEEE) 802.11ax 160 MHz High-Efficiency (HE)-LTF sequence such that the LTF is used in the wireless communication in the 480 MHz or 640 MHz bandwidth.

10. The method of claim 1, wherein the generating of the LTF comprises generating the LTF of the PPDU using an Institute of Electrical and Electronics Engineers (IEEE) 802.11ax 160 MHz High-Efficiency (HE)-LTF sequence and an IEE 802.11ax 80 MHz HE-LTF sequence such that the LTF is used in the wireless communication in the 240 MHz bandwidth.

11. An apparatus, comprising:
a transceiver configured to transmit and receive wirelessly; and
a processor coupled to the transceiver and configured to perform operations comprising:
generating a long-training field (LTF) of a physical-layer protocol data unit (PPDU) with a 78.125 kHz subcarrier spacing by using a predefined LTF base sequence; and
performing, via the transceiver, a wireless communication in a 240 MHz, 480 MHz or 640 MHz bandwidth with the PPDU.

12. The apparatus of claim 11, wherein the generating of the LTF comprises generating the LTF of the PPDU using an Institute of Electrical and Electronics Engineers (IEEE) 802.11be 80 MHz subblock base sequence such that the LTF is used in the wireless communication in the 240 MHz, 480 MHz or 640 MHz bandwidth.

13. The apparatus of claim 12, wherein the generating of the LTF further comprises generating the LTF of the PPDU using a combination of optimized coefficients such that the LTF is used in the wireless communication in the 240 MHz bandwidth, and wherein:
$$the LTF = [ c ( 1 ) * {LTF}_{80 MHz \_ subblock \_ left \_ 4 x} , {0}_{5} , c ( 2 ) * {LTF}_{80 MHz \_ subblock \_ right \_ 4 x} , {0}_{23} , c ( 3 ) * {LTF}_{80 MHz \_ subblock \_ left \_ 4 x} , {0}_{5} , c ( 4 ) * {LTF}_{80 MHz \_ subblock \_ right \_ 4 x} , {0}_{23} , c ( 5 ) * {LTF}_{80 MHz \_ subblock \_ left \_ 4 x} , {0}_{5} , c ( 6 ) * {LTF}_{80 MHz \_ subblock \_ right \_ 4 x} ] ,$$
$$the combination of optimized coefficients = [ \begin{matrix}c ( 1 ) & c ( 2 ) & c ( 3 ) & c ( 4 ) & c ( 5 ) & c ( 6 )\end{matrix} ] = [ \begin{matrix}- 1 & - 1 & - 1 & 1 & 1 & 1\end{matrix} ] ,$$
LTF_{80MHz_subblock_left_4×} denotes a left half of the IEEE 802.11be 80 MHz subblock base sequence with the 78.125 kHz subcarrier spacing,
LTF_{80MHz_subblock_right_4×} denotes a right half of the IEEE 802.11be 80 MHz subblock base sequence with the 78.125 kHz subcarrier spacing,
0₅ denotes five consecutive 0s, and
0₂₃ denotes twenty-three consecutive 0s.

14. The apparatus of claim 12, wherein the generating of the LTF further comprises generating the LTF of the PPDU using a combination of optimized coefficients such that the LTF is used in the wireless communication in the 480 MHz bandwidth, and wherein:
$$LTF = [ c ( 1 ) * L T {F}_{80 MHz \_ subblock \_ left \_ 4 x} , {0}_{5} , c ( 2 ) * LT {F}_{80 MHz \_ subblock \_ right \_ 4 x} , {0}_{23} , c ( 3 ) * LT {F}_{80 MHz \_ subblock \_ left \_ 4 x} , {0}_{5} , c ( 4 ) * LT {F}_{80 MHz \_ subblock \_ right \_ 4 x} , {0}_{23} , c ( 5 ) * LT {F}_{80 MHz \_ subblock \_ left \_ 4 x} , {0}_{5} , c ( 6 ) * LT {F}_{80 MHz \_ subblock \_ right \_ 4 x} , {0}_{23} , c ( 7 ) * LT {F}_{80 MHz \_ subblock \_ left \_ 4 x} , {0}_{5} , c ( 8 ) * LT {F}_{80 MHz \_ subblock \_ right \_ 4 x} , {0}_{23} , c ( 9 ) * LT {F}_{80 MHz \_ subblock \_ left \_ 4 x} , {0}_{5} , c ( 10 ) * LT {F}_{80 MHz \_ subblock \_ right \_ 4 x} , {0}_{23} , c ( 11 ) * LT {F}_{80 MHz \_ subblock \_ left \_ 4 x} , {0}_{5} , c ( 12 ) * LT {F}_{80 MHz \_ subblock \_ right \_ 4 x} ] ,$$
$$the combination of optimized coefficients = [ \begin{matrix}c ( 1 ) & c ( 2 ) & c ( 3 ) & c ( 4 ) & c ( 5 ) & \begin{matrix}c ( 6 ) & c ( 7 ) & c ( 8 ) & c ( 9 ) & c ( 10 ) & c ( 11 ) & c ( 12 )\end{matrix}\end{matrix} ] = [ \begin{matrix}- 1 & - 1 & - 1 & 1 & 1 & \begin{matrix}- 1 & 1 & - 1 & - 1 & 1 & - 1 & - 1\end{matrix}\end{matrix} ] ,$$
LTF_{80MHz_subblock_left_4×} denotes a left half of the IEEE 802.11be 80 MHz subblock base sequence with the 78.125 kHz subcarrier spacing,
LTF_{80MHz_subblock_right_4×} denotes a right half of the IEEE 802.11be 80 MHz subblock base sequence with the 78.125 kHz subcarrier spacing,
0₅ denotes five consecutive 0s, and
0₂₃ denotes twenty-three consecutive 0s.

15. The apparatus of claim 12, wherein the generating of the LTF further comprises generating the LTF of the PPDU using a combination of optimized coefficients such that the LTF is used in the wireless communication in the 640 MHz bandwidth, and wherein:
$$LTF = [ c ( 1 ) * L T {F}_{80 MHz \_ subblock \_ left \_ 4 x} , {0}_{5} , c ( 2 ) * LT {F}_{80 MHz \_ subblock \_ right \_ 4 x} , {0}_{23} , c ( 3 ) * LT {F}_{80 MHz \_ subblock \_ left \_ 4 x} , {0}_{5} , c ( 4 ) * LT {F}_{80 MHz \_ subblock \_ right \_ 4 x} , {0}_{23} , c ( 5 ) * LT {F}_{80 MHz \_ subblock \_ left \_ 4 x} , {0}_{5} , c ( 6 ) * LT {F}_{80 MHz \_ subblock \_ right \_ 4 x} , {0}_{23} , c ( 7 ) * LT {F}_{80 MHz \_ subblock \_ left \_ 4 x} , {0}_{5} , c ( 8 ) * LT {F}_{80 MHz \_ subblock \_ right \_ 4 x} , {0}_{23} , c ( 9 ) * LT {F}_{80 MHz \_ subblock \_ left \_ 4 x} , {0}_{5} , c ( 10 ) * LT {F}_{80 MHz \_ subblock \_ right \_ 4 x} , {0}_{23} , c ( 11 ) * LT {F}_{80 MHz \_ subblock \_ left \_ 4 x} , {0}_{5} , c ( 12 ) * LT {F}_{80 MHz \_ subblock \_ right \_ 4 x} , {0}_{23} , c ( 13 ) * {LTF}_{80 MHz \_ subblock \_ left \_ 4 x} , {0}_{5} , c ( 14 ) * LT {F}_{80 MHz \_ subblock \_ right \_ 4 x} , {0}_{23} , c ( 15 ) * LT {F}_{80 MHz \_ subblock \_ left \_ 4 x} , {0}_{5} , c ( 16 ) * LT {F}_{80 MHz \_ subblock \_ right \_ 4 x} , ] ,$$
$$\begin{matrix}the combination of optimized coefficients = [ \begin{matrix}\begin{matrix}\begin{matrix}c ( 1 ) & c ( 2 ) & c ( 3 ) & c ( 4 ) & c ( 5 ) & c ( 6 )\end{matrix} \\ c \begin{matrix}c ( 7 ) & c ( 8 ) & c ( 9 ) & c ( 10 ) & c ( 11 )\end{matrix}\end{matrix} \\ \begin{matrix}c ( 12 ) & c ( 13 ) & c ( 14 ) & c ( 15 ) & c ( 16 )\end{matrix}\end{matrix} ] \\ = [ \begin{matrix}- 1 & - 1 & - 1 & 1 & 1 & 1 & 1 & - 1 \\ - 1 & - 1 & 1 & - 1 & 1 & 1 & - 1 & 1\end{matrix} ] ,\end{matrix}$$
LTF_{80MHz_subblock_left_4×} denotes a left half of the IEEE 802.11be 80 MHz subblock base sequence with the 78.125 kHz subcarrier spacing,
LTF_{80MHz_subblock_right_4×} denotes a right half of the IEEE 802.11be 80 MHz subblock base sequence with the 78.125 kHz subcarrier spacing,
0₅ denotes five consecutive 0s, and
0₂₃ denotes twenty-three consecutive 0s.

16. The apparatus of claim 11, wherein the generating of the LTF comprises generating the LTF of the PPDU using an Institute of Electrical and Electronics Engineers (IEEE) 802.11be 160 MHz extremely-high throughput (EHT)-LTF sequence such that the LTF is used in the wireless communication in the 480 MHz or 640 MHz bandwidth.

17. The apparatus of claim 11, wherein the generating of the LTF comprises generating the LTF of the PPDU using an Institute of Electrical and Electronics Engineers (IEEE) 802.11be 160 MHz extremely-high throughput (EHT)-LTF sequence and an IEE 802.11be 80 MHz EHT-LTF sequence such that the LTF is used in the wireless communication in the 240 MHz bandwidth.

18. The apparatus of claim 11, wherein the generating of the LTF comprises generating the LTF of the PPDU using an Institute of Electrical and Electronics Engineers (IEEE) 802.11ax 80 MHz subblock base sequence such that the LTF is used in the wireless communication in the 240 MHz, 480 MHz or 640 MHz bandwidth.

19. The apparatus of claim 11, wherein the generating of the LTF comprises generating the LTF of the PPDU using an Institute of Electrical and Electronics Engineers (IEEE) 802.11ax 160 MHz High-Efficiency (HE)-LTF sequence such that the LTF is used in the wireless communication in the 480 MHz or 640 MHz bandwidth.

20. The apparatus of claim 11, wherein the generating of the LTF comprises generating the LTF of the PPDU using an Institute of Electrical and Electronics Engineers (IEEE) 802.11ax 160 MHz High-Efficiency (HE)-LTF sequence and an IEE 802.11ax 80 MHz HE-LTF sequence such that the LTF is used in the wireless communication in the 240 MHz bandwidth.
